(19) United States
(12) Patent Application Publication
(10) Pub. No.: US 2009/0090307 A1
(43) Pub. Date: Apr. 9, 2009

(54) ANIMAL PROTECTIVE DEVICE AND METHOD

(76) Inventor: Jeff Heister, Chatsworth, CA (US)

Correspondence Address: SHERIDAN ROSS PC, 1560 BROADWAY, SUITE 1200, DENVER, CO, 80202, US

(21) Appl. No.: 11/868,275

(22) Filed: Oct. 5, 2007

(51) Int. Cl. A01K 15/04

(52) U.S. Cl. 119/821

(57) ABSTRACT

An animal protective device and method are provided for preventing contact of the animal's head with other parts of the animal. The device includes a body formed in a truncated cone shape. A pressure strap maintains contact with the upper portion and back portion of the animal's head in order to keep the device aligned with the nose and mouth area of the animal. An integral attachment strap is provided that is routed around the neck of the animal to further stabilize the device on the animal. The device may be adjusted at the attachment strap as well as the body to ensure that the device is correctly fitted to the animal. The device is of one-piece construction and does not require use of a separate collar, such as the identification collar of the animal.

### FIELD OF THE INVENTION

The present invention relates to a device secured to an animal to prevent contact between the head of the animal and other parts of the animal, and more particularly, to an Elizabethan collar type protective device used to protect the animal's head wherein the device is of a unitary construction and has multiple points of adjustment to fit the device to animals of different sizes.

### BACKGROUND OF THE INVENTION

Protective animal collars, often referred to as “Elizabethan collars” based upon the appearance when secured to the animal, are well known in veterinary medicine to protect against contact between the animal's head and neck area with other parts of its body. Animals who have been injured or who have undergone surgery may have a wound, and an animal's natural instinct is to scratch, bite, or lick the wound thereby delaying healing of the wound. A typical Elizabethan collar has the shape of a truncated cone, and the smaller end of the truncated cone is secured to the neck of the animal.

There are a number of references that disclose various forms of Elizabethan collars, as well as various means for adjusting the size of the collar to the particular animal. Elizabethan collars may be made of various materials that are relatively sturdy, yet flexible. Flexible plastic is one well-known material used for Elizabethan collars.

Many disadvantages exist with respect to current Elizabethan collar designs. One distinct disadvantage with such designs is that they are physically uncomfortable for the animal, because the collars may have thin attachment rims and are prone to chafe or otherwise gouge the neck region of the animal. Another disadvantage with many prior art designs is that the cone or funnel-shaped design is inherently unstable, and maintaining the shape of the cone and its correct orientation with respect to the animal's head is problematic. Thus, the Elizabethan collar may shift or remain in connect with one side of the animal's head, rather than maintaining a symmetric orientation with respect to the animal's head.

Yet another clear disadvantage with respect to many Elizabethan collar designs is that they require attachment to the animal's identification collar, thus, the Elizabethan collar is not an integral, one-piece design that may be simply attached to the animal without first attaching and adjusting the Elizabethan collar to the identification collar of the animal.

U.S. Pat. No. 4,200,057 discloses an Elizabethan collar having a truncated cone-shape. A non-chafing ring protects an inner circular edge that contacts the animal's neck. The device is constructed from a sheet of flat material in which the funnel shape is formed by drawing together opposing ends of the material, and joining them together preferably by overlapping.

U.S. Pat. No. 5,197,414 discloses an animal protective collar made of a reticulated material whereby water cannot pool inside the collar. The collar is formed in a truncated cone or funnel-shape and fitted to the neck of the animal. The reticulated material may be held in the cone-shape by a complimentary male and female hook fastening arrangement positioned concentrically for selectively sizing the collar. The protective collar is particularly useful for protecting a groomer from being bitten during shampooing or grooming of the animal.

U.S. Pat. No. 5,012,764 discloses another example of an Elizabethan collar. Specifically disclosed is a method of fitting the collar in order to ensure compliant reapplication after the collar has been removed from the animal's neck. The collar includes a substantially flat collar-forming sheet of resiliently flexible material that is formed in the cone shape by a positionable closure assembly such as a hook and loop fastening system.

International Publication No. WO2007/059555 discloses a protective visor for use on an animal comprising a body formed to the general shape of the animal's head. The body includes an upper portion adapted to fold around the animal's snout so as to form a front opening for the animal's mouth and nostrils. A rear portion is adapted to fold over the rear of the animal's head so as to form two ear openings. The body includes a compliant internal pressure strap adapted to hold the visor snuggly in engagement with the animal's head when fitted thereto.

Although the prior art may be adequate for its intended purposes, there are still deficiencies that exist with the prior art designs to include providing a protective device which maximizes comfort for the animal, yet achieves the primary purpose of the collar to prevent contact of the animal's head area with other parts of the animal. Furthermore, a need still exists for a protective device that is durable, easily secured to the animal, and that remains oriented in its proper position with respect to the animal's head during use. Additionally, a need still exists for providing a protective device that is relatively simple to manufacture, and is of an integral or one-piece construction such that it is not required to be used with any other equipment such as an existing identification collar.

### SUMMARY OF THE INVENTION

In accordance with the present invention, an animal protective device is provided for preventing undesirable contact between the animal's head and other parts of the animal. In a preferred embodiment of the present invention, the protective device includes a body formed in the shape of a truncated cone, a stabilizing pressure strap that maintains contact with the upper portion of the animal's head, and an attachment strap for securing the device to the neck area of the animal.

The protective device is preferably constructed of a lightweight, resilient, flexible, and translucent or clear material thereby maximizing comfort for the animal. The device is made from a single piece of material and, therefore, does not require additional pieces or elements, such as the animal's identification collar. In the preferred embodiment of the present invention, adjustable fasteners are provided to selectively adjust the general size of the body, yet ensuring that the fasteners adequately connect the opposite free ends of the body in a manner that causes the body to maintain its truncated cone shape. Optionally, ventilation holes may be provided in the body to facilitate better cooling and breathing of the animal.

For the stabilizing pressure strap, this element is formed by a folded strip of material extending from the rear of the device towards the interior of the truncated cone and directly above the animal's head. The stabilizing pressure strap maintains sufficient pressure upon the upper portion of the animal's head thereby ensuring that the body of the device maintains an aligned symmetrical relationship with the animal's head and particularly the nose, and mouth area, thus preventing shifting of the body against the animal's mouth or nose area. The attachment strap extends from a bridge section that interconnects the stabilizing pressure strap to the body. The attachment strap thereby eliminates the need for using a separate collar, such as the animal's identification collar. The stabilizing pressure strap as well as the attachment strap are adjustable such that the protective device can be conveniently secured to animals of many different sizes.

Other objects and features of the present invention will become apparent by reviewing the following detailed description taken with the accompanying drawings.

### BRIEF DESCRIPTION OF THE DRAWINGS

FIG. 1 is a perspective view of a prior art device fitted to an animal's collar.

FIG. 2 shows the prior art device of FIG. 1 secured to an animal, such as a dog;

FIG. 3 is a perspective view of another prior art device;

FIG. 4 shows the prior art device of FIG. 3 in an unassembled plan view;

FIG. 5 is a perspective view of a preferred embodiment of the present invention secured to an animal;

FIG. 6 is a reversed perspective view of the present invention secured to the animal;

FIG. 7 is an unassembled plan view of the present invention;

FIG. 8 is a perspective view of the present invention taken from the rear or backside of the invention looking towards the front;

FIG. 9 is a bottom plan view of the present invention;

FIG. 10 is another perspective view as shown in FIG. 8 illustrating the adjustable feature of the body;

FIG. 11 is another perspective view as shown in FIG. 8 illustrating the adjustable nature of the attachment strap;

FIG. 12 is a rear view of the prior art device of FIG. 3; and

FIG. 13 is a rear view of the present invention.

### DETAILED DESCRIPTION

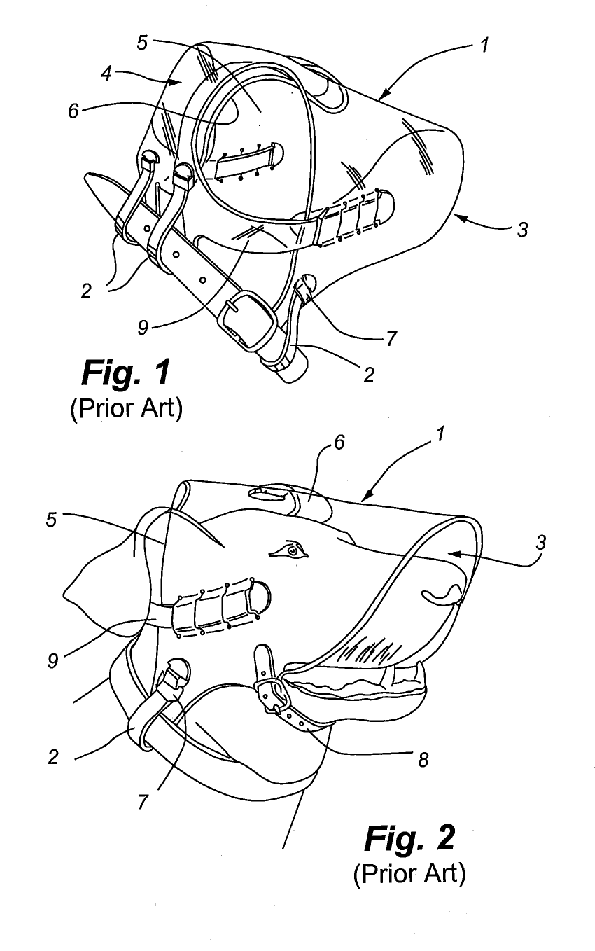

FIG. 1 is a perspective view of the prior art disclosed in WO-2007/059555. As shown, a protective visor for use on a dog or other animal comprises a body 1 conformed to the general shape of the animal's head. The body includes an upper portion adapted to fold around the animal's snout so as to form a front opening 3 for the animal's mouth and nostrils, and a rear portion 4 adapted to fold over the rear of the animal's head so as to form two ear openings 5. The body includes a compliant internal pressure strap 6 adapted to hold the visor snuggly in engagement with the animal's head when fitted thereto. The visor body is preferably provided in a flat form being easily fitted to animal by drawing the straps extending from the visor body around the animal's snout and ears and fitting the free ends of the straps to the corresponding parts of the visor body. The straps may include a chin strap 8 which, when drawn underneath the animal's chin and fitted to the appropriate receiving slot 7 or buckle, causes the upper portion of the visor to fold around the animal's snout comfortably leaving the front opening 3. The body may be further provided with ear straps 9 extending from the rear portion of the body such that the ear straps can allow the rear portion 4 to be drawn back over the back of the animal's head, underneath the animal's ears and fitted to the corresponding receiving slots 7 or buckles to the upper portion of the body 1. A plurality of collar straps 2 provide additional anchor means for the visor that can be further supported on a dog's head by passing the collar straps around the collar worn by the dog or animal.

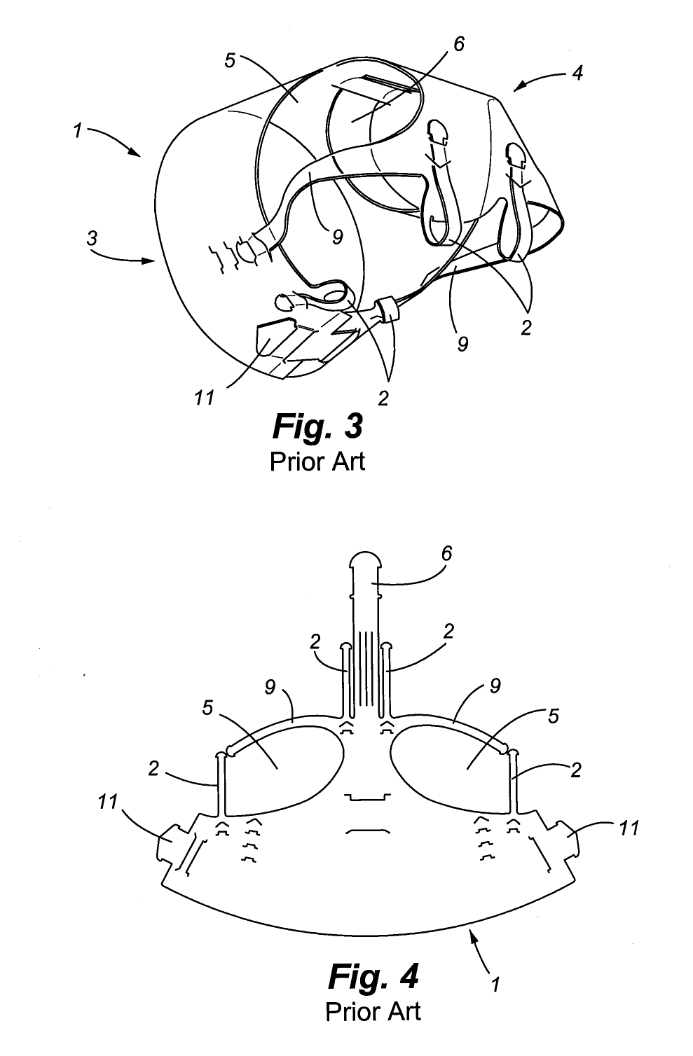

Referring to FIGS. 3 and 4, another prior art device is shown. This device is very similar to prior art shown in FIGS. 1 and 2. The primary differences in this device are that the body 1 are formed in a truncated cone shape, and means 11 are provided for adjusting the size of the body. The means 11 comprise a pair of interlocking tabs that may be fitted in a corresponding slot; a plurality of slots being provided to adjust the size. Additionally, the device in FIGS. 3 and 4 does not have a chinstrap 8. Otherwise, the same reference numbers used in FIGS. 3 and 4 correspond to the same general structure shown in the device in FIGS. 1 and 2. FIG. 4 shows the unassembled plan view of the prior art device of FIG. 3, noting particularly that the ear straps 9 have a generally curved shape, and one pair of collar straps 2 extend substantially parallel with the internal pressure strap 6.

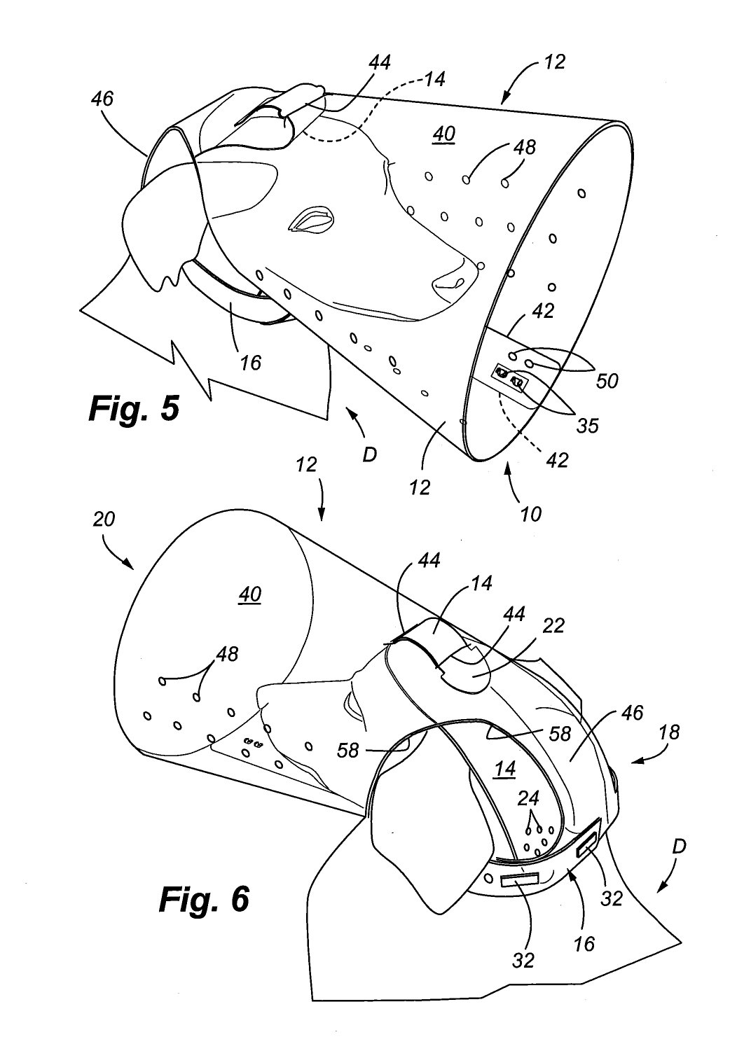

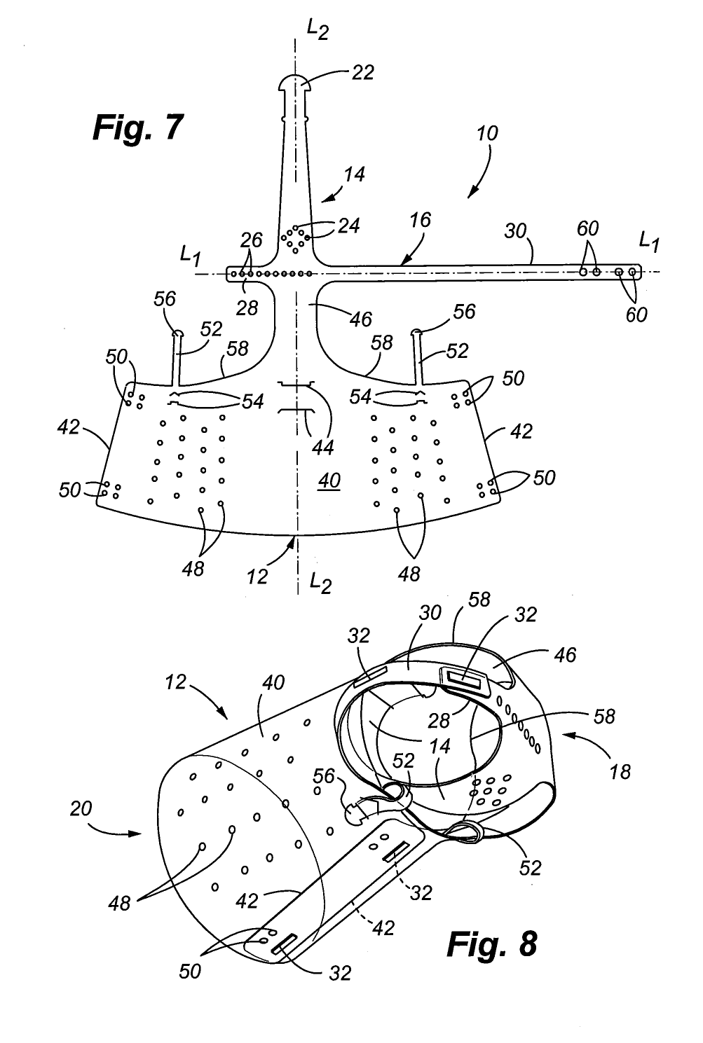

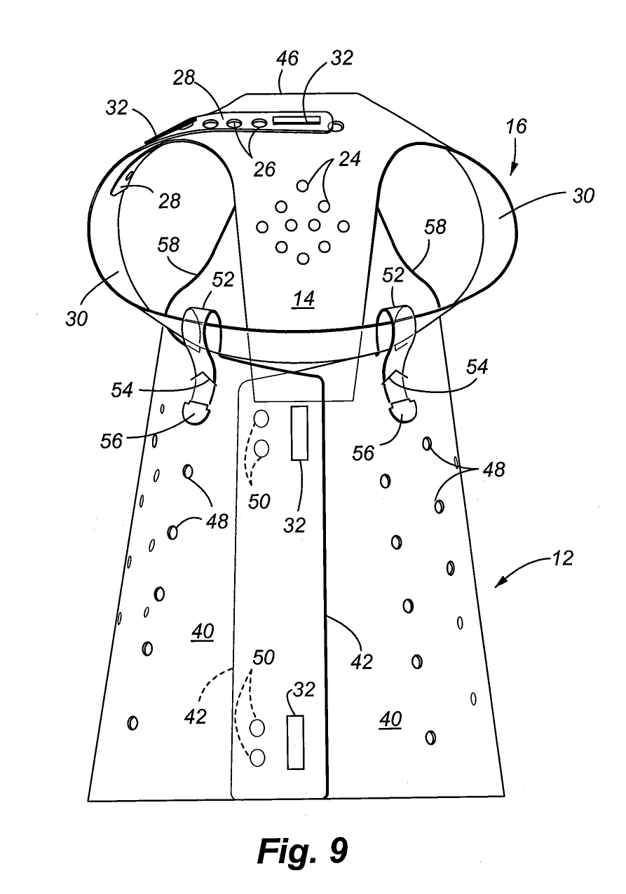

FIGS. 5-9 illustrate the preferred embodiment of the present invention. FIGS. 5 and 6 illustrate the preferred embodiment secured to an animal such as a dog D. FIG. 7 is an unassembled plan view of the present invention. FIG. 8 is a perspective view of the invention taken from the rear or backside of the invention looking toward the front portion, and FIG. 9 is a bottom plan view.

Referring particularly to FIGS. 7-9, the device 10 of the present invention includes three main or primary components, namely, a body 12, a stabilizing pressure strap 14, and an attachment strap 16. A rear or backside 18 of the device is defined as that part of the device that is secured to the back portion of the animal's head. The front portion 20 defines the body 12 that has a truncated cone shape.

The stabilizing pressure strap 14 includes a closure tab 22 formed at the free distal end thereof which is received in slots 44 when the device is assembled. Referring to FIGS. 5, 6, 8 and 9, the stabilizing pressure strap 14 is routed through the interior of the device so that the strap is aligned for contact with the upper and rear portions of the animal's head. The closure tab 22 is routed through the slots 44 such that the closure tab 22 is prevented from being pulled back through the slots 44 based upon the size of the slots and the opposite side edges of the closure tab.

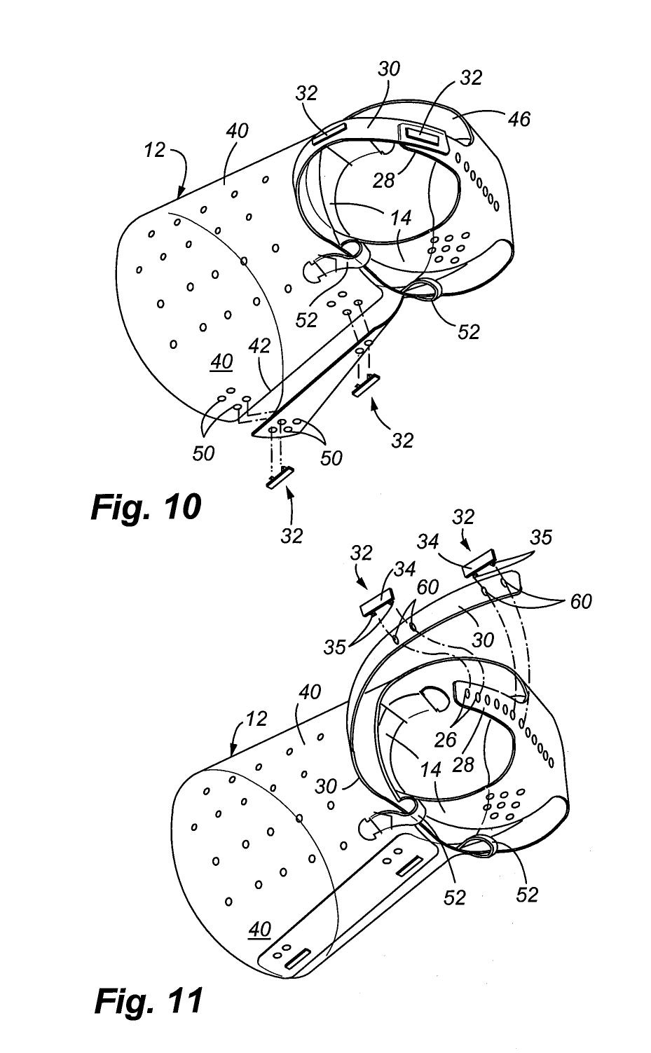

Referring to FIG. 7, an attachment strap 16 is oriented substantially perpendicular with the stabilizing pressure strap 14. The attachment strap 16 has a short section 28, and a long section 30 that extends in an opposite direction from the short section, the long and short sections extending linearly and aligned along a common longitudinal axis L₁. A plurality of adjustment holes 26 are formed in the short section 28 and extend into bridge section 46 that interconnects the main panel 40 of the body 12 to the stabilizing pressure strap 14 and attachment strap 16. The bridge section 46 is longitudinally aligned with the stabilizing pressure strap 14 along a common longitudinal axis L₂, this axis being arranged substantially perpendicular with respect to the longitudinal axis L₁ of the attachment strap. The longitudinal axis L₂ of the stabilizing pressure strap and bridge section bisects the main panel 40. The main panel 40 may include a plurality of vent holes 48, shown as two groups of vent holes arranged on opposite sides of the main panel 40. The side edges 42 of the main panel are drawn together as shown in FIGS. 8 and 9 thus forming the truncated cone shape of the body 12. As illustrated, some overlap is provided between the side edges 42 when drawing the side edges together to form the truncated cone shape. A plurality of receiving holes 50 are formed directly adjacent each of the side edges 42. Referring now also to FIGS. 10 and 11, closure elements 32 are illustrated that are used to secure side edges 42 to one another. As illustrated in FIGS. 10 and 11, the closure elements 32 may include a base 34 and one or more pins 35 that are inserted through the appropriate adjustment holes. With respect to adjusting the size of the body 12, the pins 35 of the closure elements 32 are placed in the selected holes 50. With respect to adjusting the length of the attachment strap 16 to fit the neck of the animal, the pins 35 of the closure elements are placed through the selected openings 26 and 60. Thus, three points of adjustment are provided: (i) the body 12 can be appropriately sized to fit the nose and mouth area: (ii) the attachment strap 16 may be varied in length to fit the neck of the animal; and (iii) the stabilizing pressure strap may be adjusted in length to place proper pressure on the animal's head. As also illustrated, a pair of attachment strap retainers 52 extend from opposite sides of the main panel, and these retainers 52 are used to stabilize the positioning of the attachment strap 16 about the animal's neck. The attachment strap retainers 52 include respective closure tabs 56 that are secured through slots 54.

Referring more specifically to FIGS. 5 and 6, the device of the present invention is shown secured to the animal. When assembled, large ear openings or gaps are formed on opposite sides of the bridge section 48. The ear opening edges 58 of the main panel are bounded by and enable the ears of the animal to freely protrude therethrough. The stabilizing pressure strap 14 maintains an amount of pressure on the back and upper portion of the animal's head, thereby helping to stabilize the body of the device, and ensuring that the body does not shift laterally against one side of the face of the animal or the other. The integral attachment strap 16 is also important in stabilizing the attachment of the device to the animal wherein the construction allows the device to be secured without the use of another strap, such as the identification collar of the animal.

Preferably, the device is made from a homogenous material that is rigid enough to maintain its shape during use, but maintains enough flexibility so that it does not produce undue discomfort for the animal. Additionally, the particular material should be able to maintain enough rigidity such that the stabilizing pressure strap 14 is able to maintain an adequate amount of pressure on the animal's head to keep the device oriented correctly with respect to the animal's mouth and nose area.

FIG. 10 illustrates two closure elements 32 being used to connect the opposite side edges 42 of the main panel 40. FIG. 10 also illustrates only two different positions for which to adjust the size of the main panel. However, it shall be understood that additional pin receiving holes 50 may be provided to provide further adjustability for the size of the main panel. While two closure elements are shown, only one closure element is required and additional closure elements may be used depending upon the rigidity or flexibility of the material, as well as the size of the main panel. With respect to FIG. 11, while two closure elements 32 are shown, it shall be understood that only one closure element is required, and more or less adjustment holes 26 and 60 may be provided to adequately size the attachment strap for securing it to the animal's neck.

As compared to the prior art shown in FIGS. 1-4, the present invention provides the advantage that the integral attachment strap eliminates the need to separately adjust and secure the device to the existing identification collar of the animal. Additionally, the provision of an elongated bridge section 46 provides a better base in which to stabilize or steady the traversing attachment strap. In other words, the bridge section 46 extends further along the back of the animal's head toward the neck and this additional extension results in a better stabilizing effect with respect to securing the attachment strap 16 around the side and front portion of the animal's neck. Even as compared to the prior art device shown in FIGS. 3 and 4, the use of the integral attachment strap 16 secured directly to the area between the bridge section 46 and stabilizing pressure strap 14 eliminates the need for the pair of collar straps 2 of the prior art. Also, by eliminating the ear straps 9 of the prior art, a larger opening is provided for the ears of the animal.

In accordance with the method of the present invention, the device is first assembled and then secured to the animal. During assembly, as mentioned above, the closure tab 22 is routed through the slots 44 in order to form the stabilizing pressure strap 14 that extends through the interior of the device and contacts the animal's head. Attachment strap retainers 52 are routed through their respective slots 54 thereby forming looped sections. The attachment strap 16 may then be routed through the looped sections. The attachment strap is sized to fit the particular animal by securing the closure element(s) 32 to the openings 60 in the long section 30, and then through the openings 26 in the short section 28. Thus, the method of the present invention does not require any manipulation of a separate collar, such as the identification collar of the animal. The device of the present invention is of one integral connected construction, yet provides adjustment points enabling it to be sized to a particular animal.

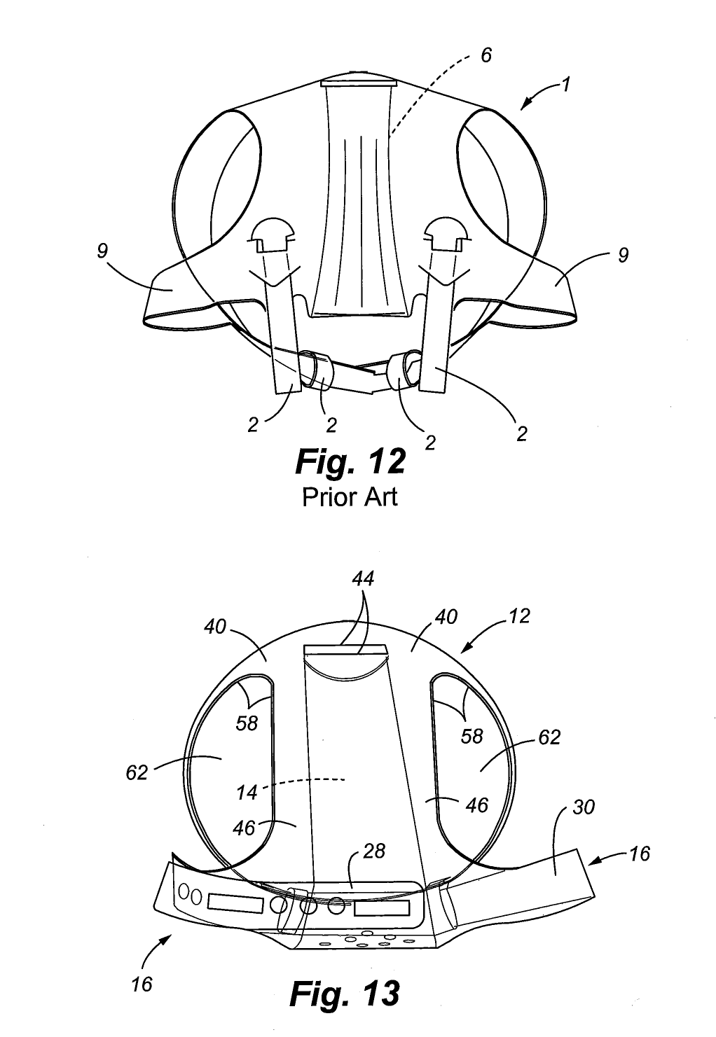

Referring now also to FIGS. 12 and 13, the advantages of the present invention are shown with respect to the integral attachment strap 16. FIG. 12 illustrates a rear view of the prior art device of FIG. 3, while FIG. 13 illustrates a rear view of the present invention. As shown, the ear openings 62 in the present invention are larger by virtue of the fact that the bridge section 46 of the present invention is longer and extends further down the back edge of the animal's head toward the neck. The larger ear openings 62 do not sacrifice stability of the present invention, but rather provides better structural stability with respect to attaching the attachment strap 16. Also, since the stabilizing pressure strap 14 extends further down the backside of the animal's head, the body 12 has additional supporting structure keep it better oriented over the animal's nose and face area. Finally, elimination of the ear strap 9 of the prior art prevents potential chafing contact with the ears.

In another aspect of the invention, the unassembled device of the present invention is used for forming the animal protective device. As mentioned above, the longitudinal axis L₂ is arranged such that the pressure strap substantially bisects the body. The attachment strap 16 is arranged substantially perpendicular to the pressure strap 14, and the short section 28 of the attachment strap resides on one lateral side of the longitudinal axis L₂ of the pressure strap, while the long section 30 of the attachment strap resides on the opposite lateral side of the longitudinal axis L₂. The attachment strap retainers 52 extend in the same direction as the pressure strap 14. The long section 30 of the attachment strap extends beyond the adjacent side edge 42. In order that the attachment strap 16 is correctly aligned with respect to the animal's neck, one important feature is that the attachment strap maintains a substantially perpendicular arrangement with respect to the longitudinal axis L₂ of the pressure strap. Accordingly, any curvature in the shape of the attachment strap 16 makes the attachment strap less functional with respect to use on most animals. Furthermore, it is desirable that the long section 30 has a length longer than the short section 28 so that a user may adjust a length of the loop formed by connecting the short and long sections at the side of the animal's neck and not at the throat region of the animal. This side adjustment position makes adjustment easier since the animal's head does not have to be lifted which would otherwise be required in most circumstances if the adjustment was located at the throat area.

Although the present invention has been described with respect to a particular preferred embodiment, it shall be understood that various other change and modifications may be made within the spirit and scope of the present invention.

What is claimed:

1. An animal protection device comprising:
a body;
a pressure strap;
a bridge section interconnecting said body and said pressure strap;
an attachment strap oriented perpendicular to said pressure strap, said attachment strap having a first longitudinal axis, and said pressure strap having a second longitudinal axis;
said second longitudinal axis of said pressure strap substantially bisects said body;
at least one attachment strap retainer extending from said body; and
when assembled, said attachment strap is formed in a loop and extends through said at least one attachment strap retainer, and said body is formed in a truncated cone shape wherein said body has opposite ends connected to one another.

2. A device, as claimed in claim 1, wherein:
said attachment strap includes a first section residing on one lateral side of said second longitudinal axis of said pressure strap, and a second section residing on an opposite lateral side of said second longitudinal axis.

3. A device, as claimed in claim 1, wherein:
said attachment strap includes a plurality of openings formed therethrough for receiving a closure element.

4. A device, as claimed in claim 1, wherein:
said body includes slots for receiving said pressure strap.

5. A device, as claimed in claim 1, wherein:
said body further includes a plurality of vent openings formed therein.

6. A device, as claimed in claim 1, wherein:
said body further includes a plurality of pin receiving holes formed therein.

7. A device, as claimed in claim 1, wherein:
said body includes a pair of edges defining ear openings, wherein said deice is assembled.

8. A device, as claimed in claim 1, wherein:
said device is of one piece, integral construction.

9. A method of protecting an animal, said method comprising the steps of providing:
(i) a body;
(ii) a pressure strap;
(iii) a bridge section interconnecting said body and said pressure strap;
(iv) an attachment strap oriented perpendicular to said pressure strap, said attachment strap having a first longitudinal axis, and said pressure strap having a second longitudinal axis;
(v) said second longitudinal axis of said pressure strap substantially bisects said body;
(vi) at least one attachment strap retainer extending from said body;
(vii) securing said pressure strap to said body;
(viii) forming a loop with said attachment strap by securing opposite ends thereof together and routing said attachment strap through a loop formed in said at least one attachment strap retainer;
(ix) fitting the device over the head of an animal wherein the nose and mouth of the animal extend through a central opening in said body, and said attachment strap is secured to the neck of the animal so that the pressure strap makes contact with the head of said animal; and
(x) adjusting a length of the attachment strap and a size of the body to fit the animal.

10. A device as claimed in claim 9, wherein.
said device is of one piece, integral construction.

11. A device for protecting an animal comprising:
(i) a body;
(ii) a pressure strap;
(iii) a bridge section interconnecting said body and said pressure strap;
(iv) an attachment strap oriented perpendicular to said pressure strap, said attachment having a first longitudinal axis and said pressure strap having a second longitudinal axis;
(v) said second longitudinal axis of said pressure strap substantially bisects said body;
(vi) at least one attachment strap retainer extending from said body and oriented substantially parallel with said second longitudinal axis; and
(vii) said device is formed from a single piece of material.
